(19) United States
(12) Patent Application Publication
(10) Pub. No.: US 2011/0153257 A1
(43) Pub. Date: Jun. 23, 2011

(54) QUANTUM STATE TRANSFER METHOD, QUANTUM STATE TRANSFER SYSTEM DEVICE, QUANTUM OPERATION METHOD AND QUANTUM OPERATION APPARATUS

(75) Inventor: Satoshi Ishizaka, Tokyo (JP)

(73) Assignee: NEC CORPORATION, Tokyo (JP)

(21) Appl. No.: 13/002,726

(22) PCT Filed: Jul. 16, 2009
(86) PCT No.: PCT/JP2009/062899

§ 371 Date: Mar. 7, 2011

(30) Foreign Application Priority Data
Jul. 17, 2008 (JP) 2008-186256

(51) Int. Cl. G06F 19/00

(52) U.S. Cl. 702/109

(57) ABSTRACT

A quantum state transfer system device comprises transmitting device that measures an input qubit and a first qubit array that includes not less than three qubits; and a receiving device that selects in accordance with the measurement result a qubit as an output qubit from among qubits included in a second qubit array that includes not less than three qubits and is quantum-mechanically entangled with the first qubit array.

### TECHNICAL FIELD

### Related Application

This application claims the benefit of Japanese Patent Application No. 2008-186256, filed Jul. 17, 2008, which is hereby incorporated by reference herein in its entirety. This invention relates to a quantum state transfer method and a quantum state transfer system device that transfer a quantum state, and also to a quantum operation method and a quantum operation apparatus that perform an operation on a quantum state.

### BACKGROUND

Quantum teleportation is defined as a transfer of a quantum state of an input qubit (quantum bit) to that of an output qubit using a pair of qubits that are in a quantum-mechanically entangled state. Two Quantum states of qubits that are orthogonal to each other are, respectively, denoted by |0> and |1>. Four Bell states of two qubits that are orthogonal to each other are, respectively, denoted by |Φ^{±}>=(|0>|0>±|1>1|>)/√2, |Ψ^{±}>=(|0>|1>±|1>|0>)/√2. The Bell state is a quantum-mechanically entangled state. An identity matrix is denoted by I, the Pauli matrices are denoted by σ_{X}, σ_{Y}, and σ_{Z}. These matrices are represented as follows: σ₀=I; σ₁=σ_{X}; σ₂=σ_{Y}; and σ₃=σ_{Z}.

Quantum teleportation (namely, transfer of a quantum state) is performed following the procedures described bellow (Non-Patent Document 1).

At first, a pair of qubits that are quantum-mechanically entangled is generated (step 1). The first qubit and second qubit of the qubit pair are denoted, respectively, by A and B. The quantum state of the qubit pair is assumed to be |Φ⁺>_{AB=}(|0>_{A}|0>_{B}+|1>_{A}|1>_{B})/√2.

Next, perform a Bell state measurement on an input qubit and the qubit A (step 2). The Bell state measurement determines correspondence of the state of two qubits to any of the four Bell states {|Φ⁺>, |Ψ⁺>, |Ψ⁻>, |Φ⁻>}. Four kinds of measurement results i (i=0 to 3) are obtained, corresponding to the four Bell states. Assume that the state (density matrix) of the input qubit is denoted by ρ, and a measurement result i is obtained through the above Bell state measurement. In this case, due to the property of the state |Φ⁺>_{AB}, the state of the qubit B is given by σᵢρσᵢ, a state generated by applying a unitary transformation σᵢ on the state ρ.

Finally, perform a unitary transformation σᵢ on the qubit B (step 3). Through this unitary transformation, the state σᵢρσᵢ a in step 2 is transformed into ρ. Therefore, the state of the input qubit is transferred to that of an output qubit by setting the qubit B after the unitary transformation as the output qubit.

In the above procedure, assume that a sender is provided with an input qubit and a qubit A, a receiver is provided with the qubit B, and the sender performs a Bell state measurement and sends the measurement result i to a receiver by an ordinary communication (hereafter called a “classical communication” to distinguish it from a quantum communication). In this case, even when the sender and the receiver are remote from each other, the sender can transfer the quantum state to the receiver.

The fact that a unitary transformation σᵢ is required in the above step 3 is closely related to the fact that a faster-than-light information transmission is prohibited by the theory of relativity (the impossibility of faster-than-light communication). After the above step 2, the state of qubit B is given by a σᵢρσᵢ. Therefore, if a receiver does not know the result i obtained through the Bell state measurement, the receiver cannot extract the original information ρ from this state. Therefore, since no information is transferred from the sender to the receiver before the result i of the Bell state measurement is transferred to the receiver, the quantum teleportation does not contradict the impossibility of faster-than-light communication.

Furthermore, the quantum teleportation can be used as a quantum operation unit (processor) that performs a quantum operation f on an input state ρ to obtain f(ρ) as an output state (Non-Patent Document 2). More concretely, the quantum operation f is performed on the qubit B after the above step 1. Next, by performing the step 2, the state of the qubit B becomes f(σᵢρσᵢ). In a case where a measurement result i=0 is obtained through the Bell state measurement in step 2, the state of the qubit B is f(ρ) because σ₀=I (identity matrix). Therefore, since an output state f(ρ) is generated for an arbitrary input state ρ, the quantum teleportation can be used as a quantum operation unit that performs a quantum operation f.

In the above quantum operation step, the quantum operation f can be performed independently of the measurement of the input state. Therefore, even in a case where it takes much time to perform the quantum operation f, the operation in the quantum operation unit can be accelerated by performing the measurement of the input state and the quantum operation f simultaneously.

However, in a case where the result i of the Bell state measurement in the above step 2 is not equal to zero (i≠0), the state of the qubit B become f(σᵢρσᵢ), which does not equal to f(ρ). Since the quantum operation f and the unitary transformation σ₁ is not commutable in general, it is impossible to obtain the desired output state f(ρ) by performing the unitary transformation σᵢ on the state f(σᵢρσᵢ). Therefore, the quantum operation f fails.

In Patent Document 1, a quantum teleportation device and a controlled-NOT operation device are described. In Patent Document 2, an efficient quantum state transfer method using a squeezed state is described. In Patent Document 3, a quantum communication method to realize a qubit teleportation is described.

### [Patent Document 1]

Japanese Patent Kokai Publication No. JP2005-172910A

### [Patent Document 2]

Japanese Patent Kokai Publication No. JP2007-143085A

### [Patent Document 3]

Japanese Patent Kokai Publication No. JP-A-11-112495A

### [Non-Patent Document 1]

C. H. Bennett, G. Brassard, C. Crepeau, R. Jozsa, A. Peres, and W. K. Wootters, “Teleporting an unknown quantum state via dual classical and Einstein-Podolsky-Rosen channels,” Physical Review Letters, Vol. 70, p. 1895 (1993).

### [Non-Patent Document 2]

M. A. Nielsen and I. L. Chuang, “Programmable Quantum Gate Arrays,” Physical Review Letters, Vol. 79, p. 321 (1997).

### SUMMARY

It should be noted that contents disclosed in the above Patent Documents and Non-Patent Documents are hereby incorporated herein by reference thereto in their entirety. The following analyses are given by the present invention. As described above, it is necessary to perform a unitary transformation σᵢ in step 3 according to the conventional quantum teleportation. Therefore, in a case where a quantum state is transferred to a remote place using the conventional quantum teleportation, the receiver has to wait for the reception of the result i of the Bell state measurement in order to perform a unitary transformation σᵢ Since it is impossible to perform the next processing on the output qubit before the unitary transformation σᵢ is performed, the receiver has to stop the information processing while waiting for the reception of the measurement result i.

Furthermore, in a case where it takes much time in the classical communication, there occurs a problem that the external noise destroys the coherence of the output qubit while waiting for the reception of the measurement result i.

Moreover, necessity of performing a unitary transformation σᵢ causes the following problem in a case where the quantum teleportation is used as a quantum operation unit. As described above, since the unitary transformation σᵢ and the quantum operation f are not commutable in general, it is impossible to obtain the desired output state f(ρ) when the result i of the Bell state measurement is not equal to zero (i≠0). The probability that the measurement result i, which is equal to zero (i=0), is obtained through the Bell state measurement is ¼. Therefore, the success probability of a quantum operation f based on a quantum operation unit that employs the conventional quantum teleportation is at most ¼.

Therefore, there is a need in the art to provide a quantum state transfer method and a quantum state transfer system that do not require application of unitary transformation.

Further, there is a need in the art to provide a quantum state transfer method and quantum state transfer system device that make it possible for a receiver to proceed to the next processing on the output qubit without waiting for the arrival of the classical communication from a sender, when the sender of the quantum state and receiver are remote from each other.

Moreover, there is a need in the art to provide a quantum operation method and quantum operation apparatus that make it possible to perform a quantum operation prior to an input state and to obtain a desired output state with high success probability.

According to a first aspect of the present invention, there is provided a quantum state transfer method, comprising:

measuring by a transmitting device an input qubit and a first qubit array that includes not less than three qubits; and
selecting by a receiving device in accordance with the measurement result a qubit as an output qubit from among qubits included in a second qubit array that includes not less than three qubits and is quantum-mechanically entangled with the first qubit array.

In a first mode, a quantum state transfer method may further comprise generating by a qubit generation device the first and second qubit arrays.

In a second mode, a quantum state transfer method may further comprise quantum-mechanically entangling by the qubit generation device the first and second qubit arrays.

In a quantum state transfer method in a third mode, the first qubit array, second qubit array, the input qubit, and the output qubit may be, respectively, a composite of a plurality of qubits or a quantum system with not less than three quantum levels.

In a quantum state transfer method in a fourth mode, the measurement may be a POVM (Positive Operator Valued Measure) measurement.

According to a second aspect of the present invention, there is provided a quantum operation method, comprising:

measuring by a quantum operation apparatus an input qubit and a first qubit array that includes not less than three qubits;
performing a quantum operation on qubits included in a second qubit array that includes not less than three qubits and is quantum-mechanically entangled with the first qubit array; and
selecting in accordance with the measurement result a qubit as an output qubit from among qubits on which the quantum operation has been performed.

In a fifth mode a quantum operation method may further comprise generating by the quantum operation apparatus the first and second qubit arrays.

In a sixth mode, a quantum operation method may further comprise quantum-mechanically entangling the first and second qubit arrays by the quantum operation device.

In a quantum operation method in a seventh mode, the first qubit array, second qubit array, the input qubit, and the output qubit may be, respectively, a composite of a plurality of qubits or a quantum system with not less than three quantum levels.

According to a third aspect of the present invention, there is provided a quantum state transfer system device, comprising:

a transmitting device that measures an input qubit and a first qubit array that includes not less than three qubits; and
a receiving device that selects in accordance with the measurement result a qubit as an output qubit from among qubits included in a second qubit array that includes not less than three qubits and is quantum-mechanically entangled with the first qubit array.

In an eighth mode, a quantum state transfer system device may further comprise a qubit generation device that generates the first and second qubit arrays, and quantum-mechanically entangles the first and second qubit arrays.

In a quantum state transfer system device in a ninth mode, the first qubit array, second qubit array, the input qubit, and the output qubit may be, respectively, a composite of a plurality of qubits or a quantum system with not less than three quantum levels.

In a quantum state transfer system device in a tenth mode, the measurement may be a POVM (Positive Operator Valued Measure) measurement.

According to a fourth aspect of the present invention, there is provided a transmitting device, comprising:

a quantum measurement unit that measures an input qubit and a first qubit array that includes not less than three qubits; and
a communication unit that transmits the measurement result to a receiving device.

According to a fifth aspect of the present invention, there is provided a receiving device comprising:

a communication unit that receives a result of a measurement on an input qubit and a first qubit array that includes not less than three qubits; and
a qubit selection unit that selects in accordance with the measurement result a qubit as an output qubit from among qubits included in a second qubit array that includes not less than three qubits and is quantum-mechanically entangled with the first qubit array.

According to a sixth aspect of the present invention, there is provided a quantum operation apparatus comprising:

a quantum measurement unit that measures an input qubit and a first qubit array that includes not less than three qubits;
a quantum operation unit that performs a quantum operation on qubits included in a second qubit array that includes not less than three qubits and is quantum-mechanically entangled with the first qubit array; and
a qubit selection unit that selects in accordance with the measurement result a qubit as an output qubit from among the qubits on which the quantum operation has been performed.

In an eleventh mode, a quantum operation apparatus may further comprise a qubit generation unit that generates the first and second qubit arrays, and quantum-mechanically entangles the generated first and second qubit arrays.

In a quantum operation apparatus in a twelfth mode, the first qubit array, second qubit array, the input qubit, and the output qubit may be, respectively, a composite of a plurality of qubits or a quantum system with not less than three quantum levels.

The present invention provides the following advantage, but not restricted thereto. The present invention provides a quantum state transfer method and a quantum state transfer system device that do not require application of unitary transformation.

### BRIEF DESCRIPTION OF THE DRAWINGS

FIG. 1 is a flowchart illustrating a quantum state transfer method according to a first exemplary embodiment.

FIG. 2 is a flowchart illustrating a quantum state transfer method according to the first exemplary embodiment.

FIG. 3 is a flowchart illustrating a quantum operation method according to a second exemplary embodiment.

FIG. 4 is a flowchart illustrating a quantum operation method according to the second exemplary embodiment.

FIG. 5 is a block diagram illustrating a structure of a quantum state transfer system device according to a third exemplary embodiment.

FIG. 6 is a block diagram illustrating a structure of a quantum state transfer system device according to the third exemplary embodiment.

FIG. 7 is a block diagram illustrating a structure of a transmitting device according to a fourth exemplary embodiment.

FIG. 8 is a block diagram illustrating a structure of a receiving device according to a fifth exemplary embodiment.

FIG. 9 is a block diagram illustrating a structure of a quantum operation apparatus according to a sixth exemplary embodiment.

FIG. 10 is a block diagram illustrating a structure of a quantum state transfer system device according to a first example.

FIG. 11 is a block diagram illustrating an average transfer fidelity in a quantum state transfer system device according to the first example.

FIG. 12 is a block diagram illustrating a structure of a quantum operation apparatus according to a second example.

### PREFERRED MODES

### First Exemplary Embodiment

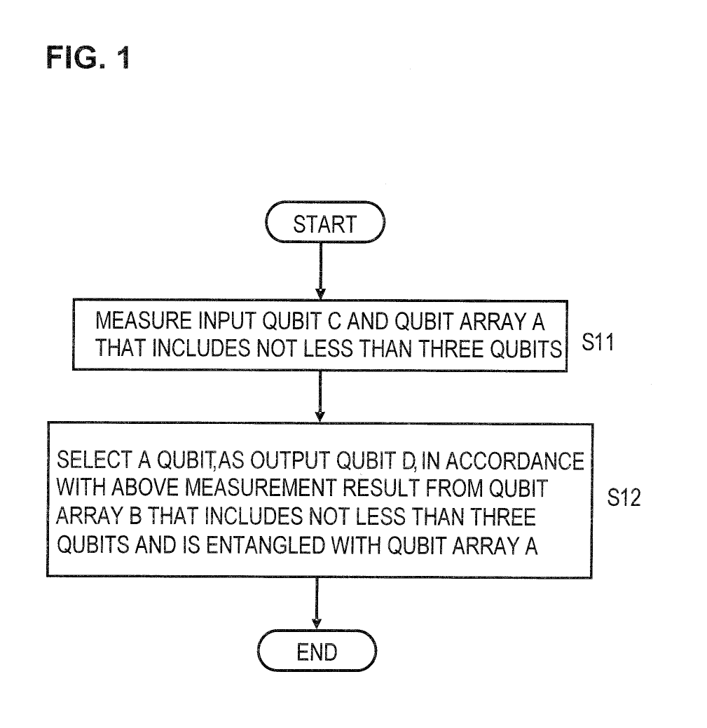

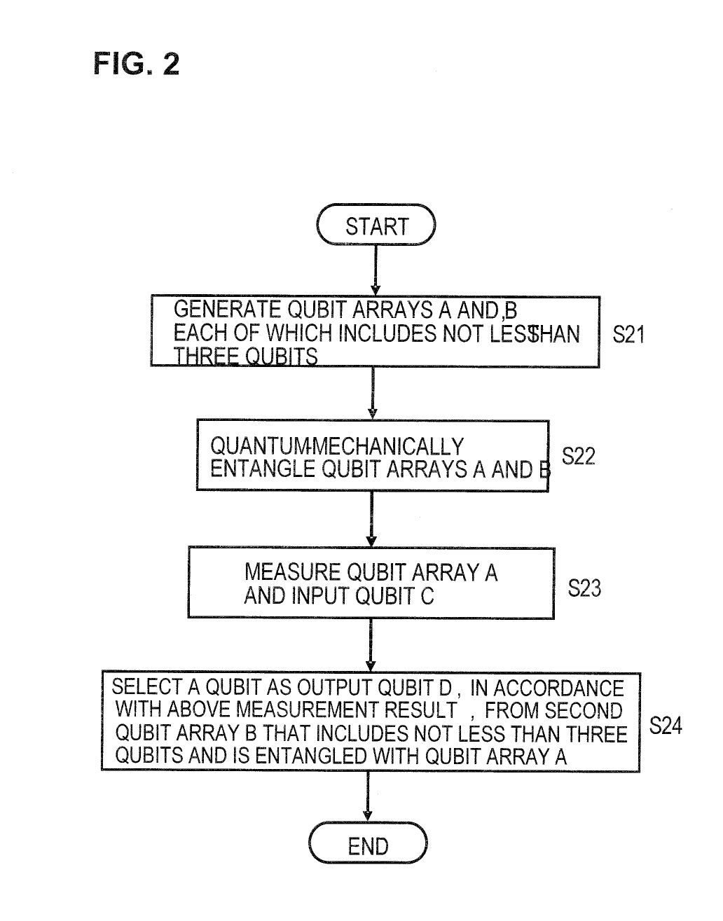

A quantum state transfer method according to a first exemplary embodiment is described with reference to the drawings. FIGS. 1 and 2 are a flowchart illustrating a quantum state transfer method according to the present exemplary embodiment.

With reference to FIG. 1, measure an input qubit C and a qubit array A that includes not less than three qubits (step S11).

Next, select in accordance with the above measurement result a qubit as an output qubit D from qubits included in a qubit array B that includes not less than three qubits and is quantum-mechanically entangled with the qubit array A (step S12).

With reference to FIG. 2, the quantum state transfer method may further include generating the above qubit arrays A and B (step S21 of FIG. 2).

With reference to FIG. 2, the quantum state transfer method may further include: quantum-mechanically entangling the above qubit arrays A and B (step S22 of FIG. 2).

The above qubit arrays A and B, the above input qubit C and output qubit D may be, respectively, a composite of a plurality of qubits or a quantum system with not less than three quantum levels.

### Second Exemplary Embodiment

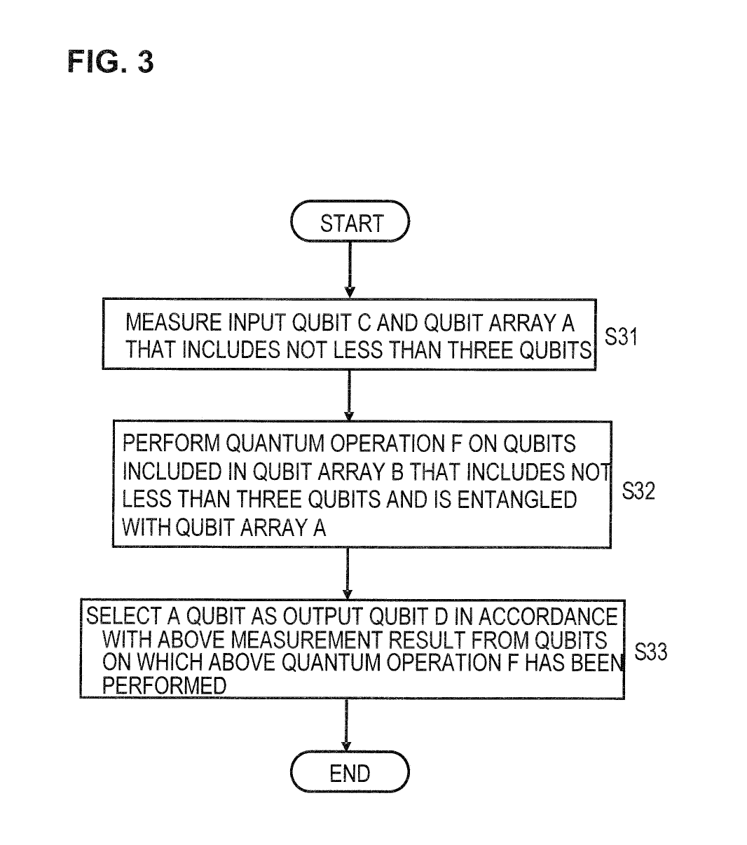

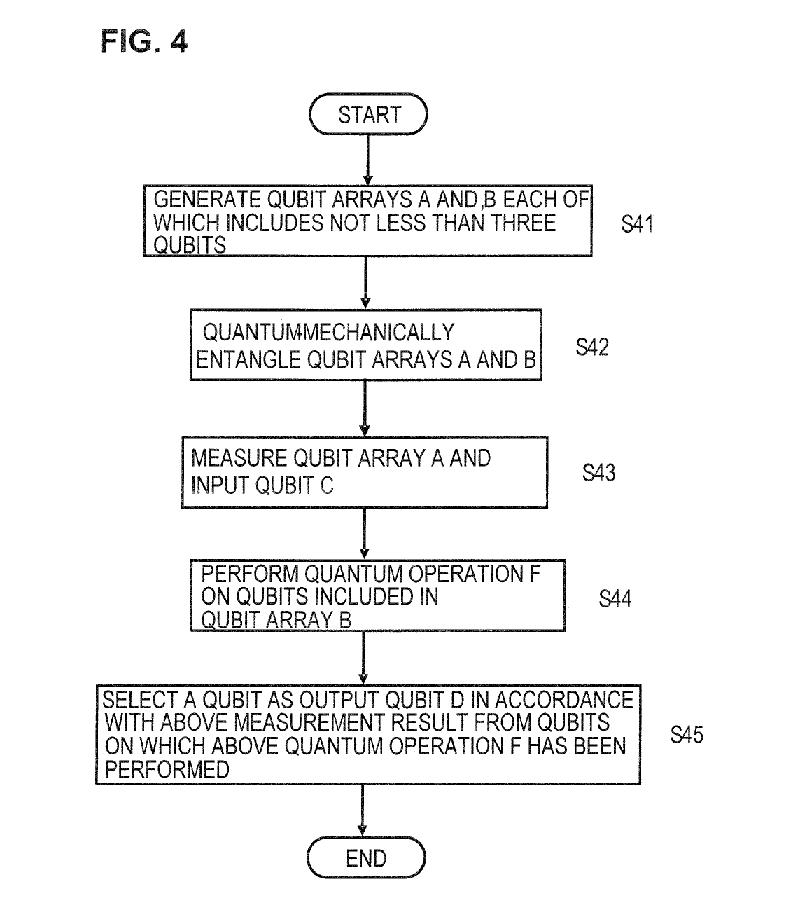

A quantum operation method according to a second exemplary embodiment is described with reference to the drawings. FIGS. 3 and 4 are a flowchart illustrating a quantum operation method according to the present exemplary embodiment.

With reference to FIG. 3, measure an input qubit C and a qubit array A that includes not less than three qubits (step S31). Next, perform a quantum operation f on qubits included in a qubit array B that includes not less than three qubits and is quantum-mechanically entangled with qubit array A (step S32). Further, select in accordance with the above measurement result a qubit as an output qubit D from among qubits on which the above quantum operation f has been performed (step S33).

With reference to FIG. 4, the quantum operation method may further include: generating the above qubit arrays A and B (step S41 of FIG. 4).

With reference to FIG. 4, the quantum operation method may further include quantum-mechanically entangling the above qubit arrays A and B (step S42 of FIG. 4).

The above qubit arrays A and B, the above input qubit C and output qubit D may be, respectively, a composite of a plurality of qubits or a quantum system with not less than three quantum levels.

### Third Exemplary Embodiment

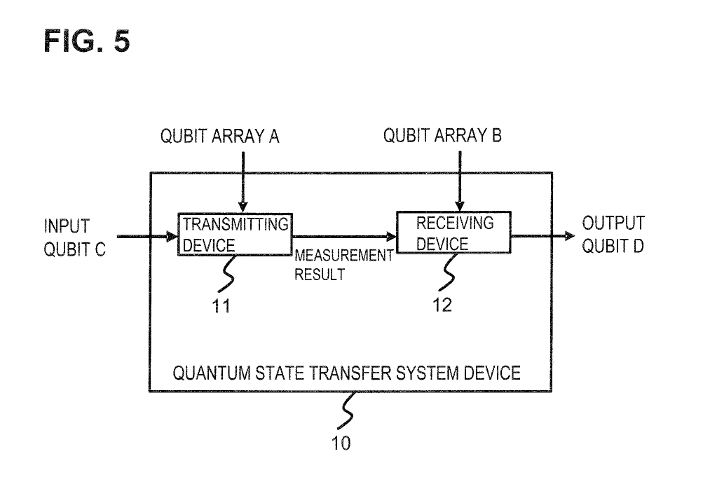

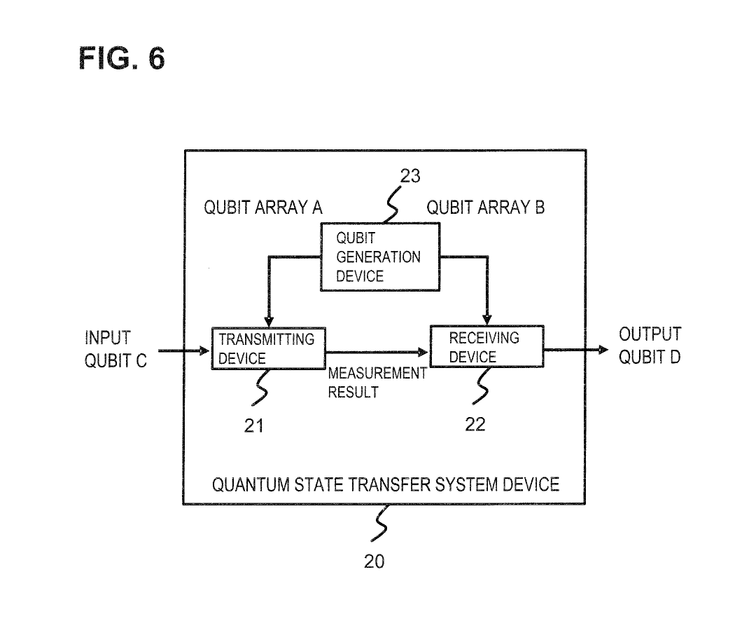

A quantum state transfer system device according to a third exemplary embodiment is described with reference to the drawings. FIGS. 5 and 6 is a block diagram illustrating a structure of a quantum state transfer system device according to the third exemplary embodiment.

With reference to FIG. 5, the quantum state transfer system device 10 comprises a transmitting device 11 and a receiving device 12. The transmitting device 11 measures an input qubit C and a qubit array A that includes not less than three qubits. The receiving device 12 selects in accordance with above measurement result a qubit as an output qubit D from a qubit array B that includes not less than three qubits and is quantum-mechanically entangled with the qubit array A.

With reference to FIG. 6, a quantum state transfer system device 20 comprises a transmitting device 21, a receiving device 22, and a qubit generation device 23. The qubit generation device 23 generates the above qubit arrays A and B, and quantum-mechanically entangles the above qubit arrays A and B.

The above qubit arrays A and B, the above input qubit C and output qubit D may be, respectively, a composite of a plurality of qubits or a quantum system with not less than three quantum levels.

### Fourth Exemplary Embodiment

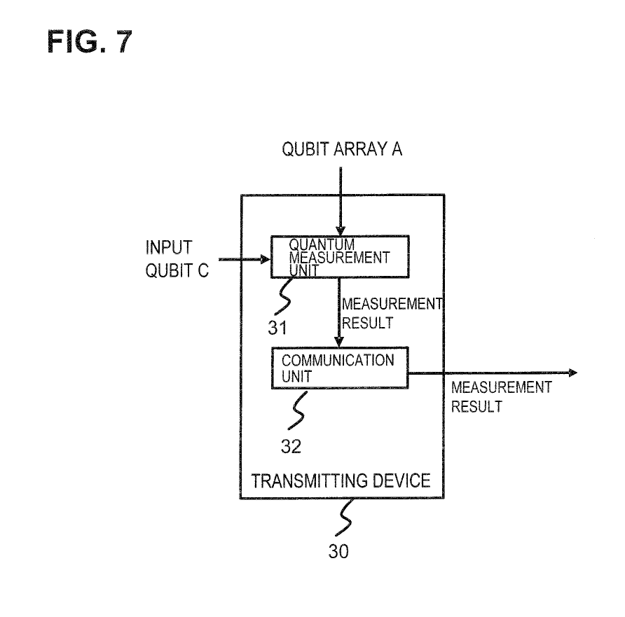

A transmitting device according to a fourth exemplary embodiment is described with reference to the drawings. FIG. 7 is a block diagram illustrating a structure of a transmitting device according to the fourth exemplary embodiment.

With reference to FIG. 7, a transmitting device 30 comprises a quantum measurement unit 31 and a communication unit 32. The quantum measurement unit 31 measures an input qubit C and a qubit array A that includes not less than three qubits. The communication unit 32 transmits the measurement result to a receiving device.

### Fifth Exemplary Embodiment

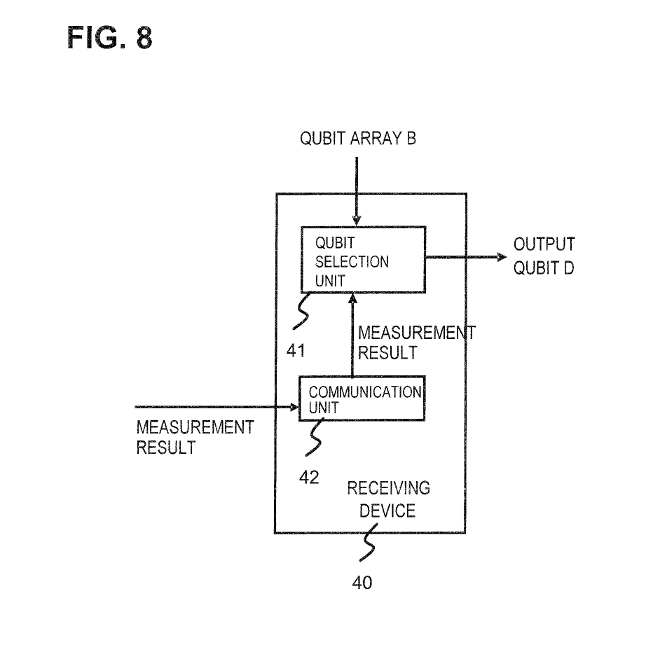

A receiving device according to a fifth exemplary embodiment is described with reference to the drawings. FIG. 8 is a block diagram illustrating a structure of a receiving device according to the fifth exemplary embodiment.

With reference to FIG. 8, the receiving device 40 comprises a qubit selection unit 41 and a communication unit 42. The communication unit 42 receives a result of a measurement on an input qubit C and a qubit array A that includes not less than three qubits. The qubit selection unit 41 selects in accordance with the above measurement result a qubit as an output qubit D from a second qubit array B that includes not less than three qubits and is entangled with the qubit array A.

### Sixth Exemplary Embodiment

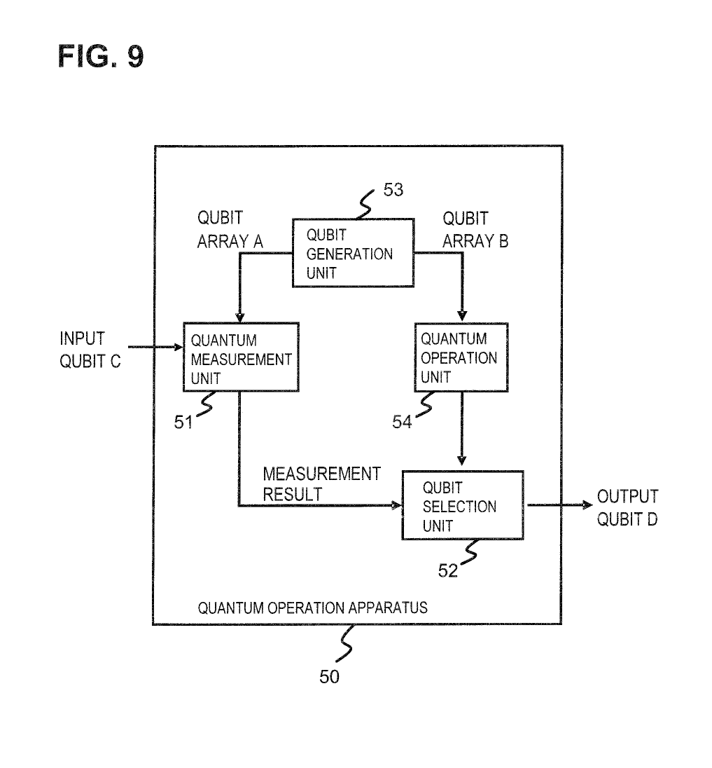

A quantum operation apparatus according to a sixth exemplary embodiment is described with reference to the drawings. FIG. 9 is a block diagram illustrating a structure of a quantum operation apparatus according to the sixth exemplary embodiment.

With reference to FIG. 9, a quantum operation apparatus 50 comprises a quantum measurement unit 51, a qubit selection unit 52, and a quantum operation unit 54.

The quantum measurement unit 51 measures an input qubit C and a qubit array A that includes not less than three qubits. The quantum operation unit 54 performs a quantum operation f on qubits included in a qubit array B that includes not less than three qubits and is entangled with the qubit array A. The qubit selection unit 52 selects in accordance with the measurement result a qubit as an output qubit D from the qubits on which the quantum operation f has been performed.

The quantum operation apparatus 50 may further comprise a qubit generation unit 53. The qubit generation unit 53 generates the above qubit arrays A and B, and quantum-mechanically entangles the generated qubit arrays.

The above qubit arrays A and B, the above input qubit C and output qubit D may be, respectively, a composite of a plurality of qubits or a quantum system with not less than three quantum levels.

### Seventh Exemplary Embodiment

A quantum transfer method according to a seventh exemplary embodiment is described.

At first, generate first and second qubit arrays, each of which includes not less than three qubits. Next, quantum-mechanically entangle the first and second qubit arrays. Next, measure an input qubit and the above first qubit array. Next, select in accordance with the above measurement result a qubit as an output qubit from the above second qubit array. In this way, the quantum state corresponding to the input qubit can be transmitted to the output qubit.

In the quantum state transfer method according to the present exemplary embodiment, two qubit arrays that are quantum-mechanically entangled each other are generated at first, and a quantum state is transmitted using the entangled state. Each of the two qubit arrays comprises not less than three qubits. In this respect, the quantum state transfer method according to the present exemplary embodiment is distinctly different from the conventional quantum teleportation, which employs a quantum-mechanically entangled pair of qubits.

As described above, the unitary transformation σᵢ, in the conventional quantum teleportation is closely related to the impossibility of faster-than-light communication. Suppose a quantum transportation based on an entangled pair of qubits be possible without unitary transformation σᵢ, the quantum state of an input qubit would be transferred instantaneously to that of an output qubit, which contradicts the impossibility of faster-than-light communication Therefore, it is impossible to realize a quantum teleportation using an entangled pair of qubits without unitary transformation σᵢ.

In the quantum state transfer method according to the present exemplary embodiment, two qubit arrays that are quantum-mechanically entangled each other are employed, and a quantum state of the input qubit is transferred to one of the qubits included in the second qubit array. The state of the transferred qubit is kept as it is (even without a unitary transformation like σᵢ) and nearly the same with that of the input qubit. A measurement on the input qubit and the first qubit array determines to which qubit of the qubits included in the second qubit array the transfer is actually performed. Therefore, in accordance with the measurement result, one qubit is selected from the second qubit array as the output qubit. Since it is impossible to know which qubit of the second qubit array corresponds to the output qubit before the measurement result is transferred, the quantum state transfer method according to the present exemplary embodiment does not contradict the requirement of the impossibility of faster-than-light communication.

It is proved that the average transfer fidelity never exceeds the classical limit (limit imposed by classical mechanics) if the second qubit array is composed of not greater than two qubits. Therefore, the second qubit array may preferably comprise at least three qubits. Since the first qubit array should be quantum-mechanically entangled with the second qubit array, the first qubit array may also preferably comprise not less than three qubits.

A transfer of a quantum state from a remote sender to a receiver can be realized in the following manner using the quantum state transfer method according to the present exemplary embodiment. The sender is provided with the input qubit and the first qubit array, the receiver is provided with the second qubit array, and the sender measures the input qubit and the first qubit array and transfer the measurement result to the receiver through a classical communication channel.

### Eighth Exemplary Embodiment

A quantum operation method according to an eighth exemplary embodiment is described.

In order to utilize the quantum state transfer method according to the above seventh exemplary embodiment as a quantum operation method that performs an identical quantum operation f, it is sufficient to perform the quantum operation f on each of qubits included in the second qubit array after quantum-mechanically entangling the states of the first and second qubit arrays.

Next, the meritorious effects provided by the quantum state transfer method, quantum state transfer system device, quantum state operation method, and quantum state operation apparatus according to the above first to eighth exemplary embodiments are described.

According to the quantum state transfer method and quantum state transfer system device according to the above first, third to fifth, and seventh exemplary embodiments, a quantum state of an input qubit is transferred to that of an output qubit without unitary transformation that has been required in the conventional quantum teleportation procedure.

According to the quantum state transfer method and quantum state transfer system device according to the above first, third to fifth, and seventh exemplary embodiments, since the quantum state of the input qubit is transferred as it is to one of qubits included in the second qubit array, the receiver can proceed to the next processing by parallelly performing an identical processing on the all qubits included in the second qubit array, without waiting for the arrival of the classical communication from the sender.

Furthermore, according to the quantum operation method and quantum operation apparatus according to the above second, sixth, and eighth exemplary embodiment, since a quantum operation can be performed prior to an input state and it is not necessary to perform a unitary transformation that is not commutable with the quantum operation, it is possible to obtain a desired output state with high success probability.

### First Example

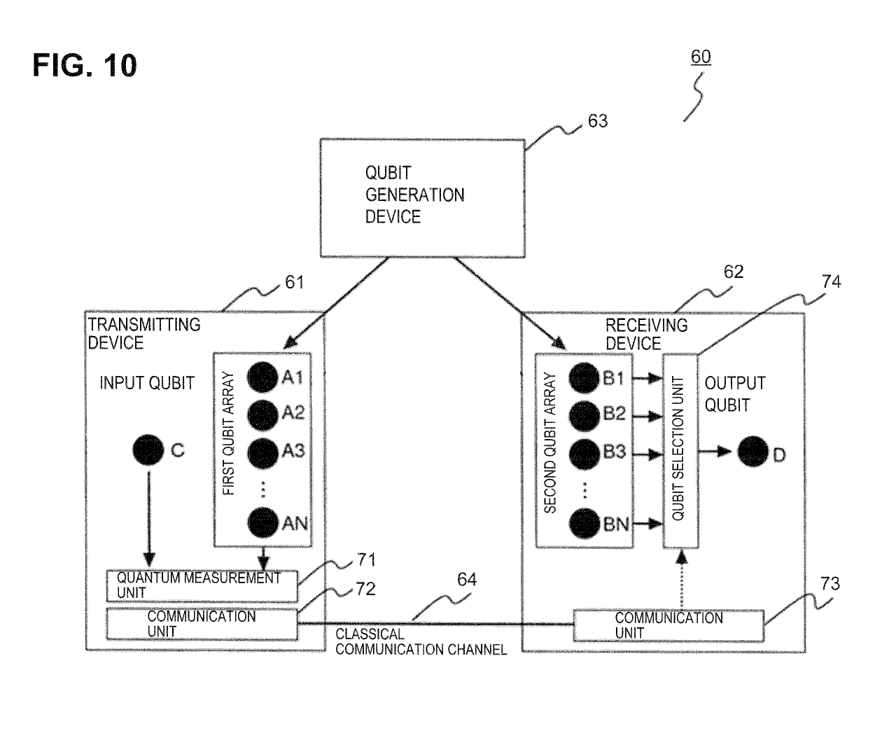

FIG. 10 is a block diagram illustrating a structure of a quantum state transfer system device according to a first example. With reference to FIG. 1, a quantum state transfer system device 60 comprises a transmitting device 61, a receiving device 62, and a qubit generation device 63.

The transmitting device 61 transmits the quantum state of an input qubit C. The receiving device 62 receives the quantum state transmitted from the transmitting device 61 as a quantum state of an output qubit D. The transmitting device 61 and the receiving device 62 are connected through a classical communication channel 64.

The qubit generation device 63 generates a first qubit array A and a second qubit array B. The qubits included in the first qubit array A are denoted by A1 to AN. The qubits included in the second qubit array B are denoted by B1 to BN. Here, N represents an integer not less than three. The qubit generation device 63 quantum-mechanically entangles the first qubit array A and the second qubit array B. The first qubit array A and the second qubit array B, which are thus entangled with each other, are distributed, respectively, to the transmitting device 61 ant the receiving device 62.

The transmitting device 61 comprises a quantum measurement unit 71 and a communication unit 72. The quantum measurement unit 71 measures an input qubit C and the first qubit array A. The communication unit 72 transmits a result of a measurement performed by the quantum measurement unit 71 to the receiving device 62 via the classical communication channel 64.

The receiving device 62 comprises a communication unit 73 and a qubit selection unit 74. The communication unit 73 receives the measurement result transmitted by the transmitting device 61 through the classical communication channel 64. The qubit selection unit 74 selects, in accordance with the measurement result received by the communication unit 73, one qubit as an output qubit D from among N qubits B1 to BN within the second qubit array B.

The transmitting device 61, receiving device 62 and qubit generation device 63 transmit the quantum state of the input qubit C to the output qubit D following the procedures described below.

At first, the qubit generation device 63 generates 2N qubits A1 to AN and B1 to BN, and generates a quantum-mechanically entangled state |φ>=|Φ⁺>_{A1B1}|Φ⁺>_{A2B2}|Φ⁺>_{A3B3} . . . |Φ⁺>_{ANBN} from quantum states of these qubits. The qubit generation device 63 distributes the qubits A1 to AN as a first qubit array A to the transmitting device 61 and the qubits B1 to BN as a second qubit array B to the receiving device 62.

Next, the quantum measurement unit 71 of the transmitting device 61 performs a generalized measurement on the input qubit C and the first qubit array A, through which N measurement results j (j=1 to N) are obtained as POVM (Positive Operator Valued Measure) elements Πⱼ.

The POVM element Πⱼ is given as follows, Πⱼ=χ^{-1/2}σ_{jχ}^{-1/2}. Furthermore, χ=σ₁+σ₂+ . . . +σ_{N}, and σₘ=(|Φ⁺><Φ⁺|)_{Cam}*I_{Am}/2^{N-1}. In the above expression; (|Φ⁺><Φ⁺|)_{Cam} represents |Φ⁺>_{Cam Cam}<Φ⁺|. Further, I_{Am} represent an identity matrix in a state space with (N−1) qubits obtained by excluding a qubit Am from the N qubits A1 to AN. The symbol * represents direct product.

The communication unit 72 of the transmitting device 61 transits the measurement result j, which is based on the above generalized measurement, to the receiving device 62.

The communication unit 73 of the receiving device 62 receives the measurement result j. The qubit selection unit 74 selects a qubit Bj as an output qubit D from the N qubits B1 to BN within the second qubit array B.

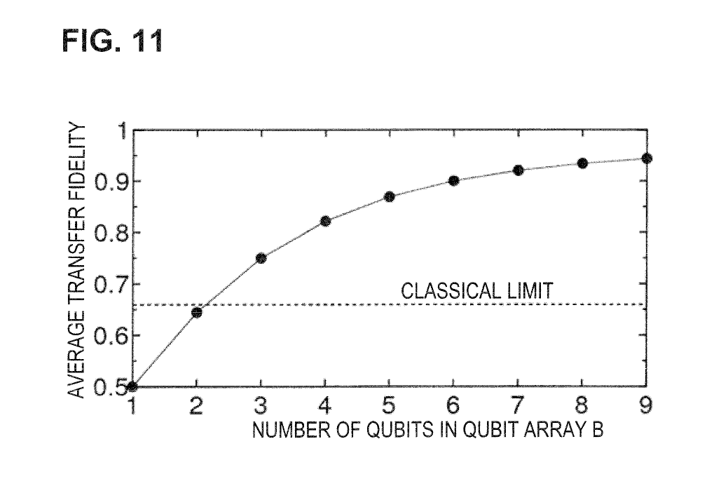

FIG. 11 represents, as a function the number of qubits N in the quantum qubit array B, average transfer fidelity obtained through numerical computation when a quantum state is transferred following the above procedure. The average transfer fidelity does not exceed the classical limit if the number of qubits N is less than three. The average transfer fidelity exceeds the classical limit if the number of qubits N is not less than three, and approaches one with increasing N.

### Second Example

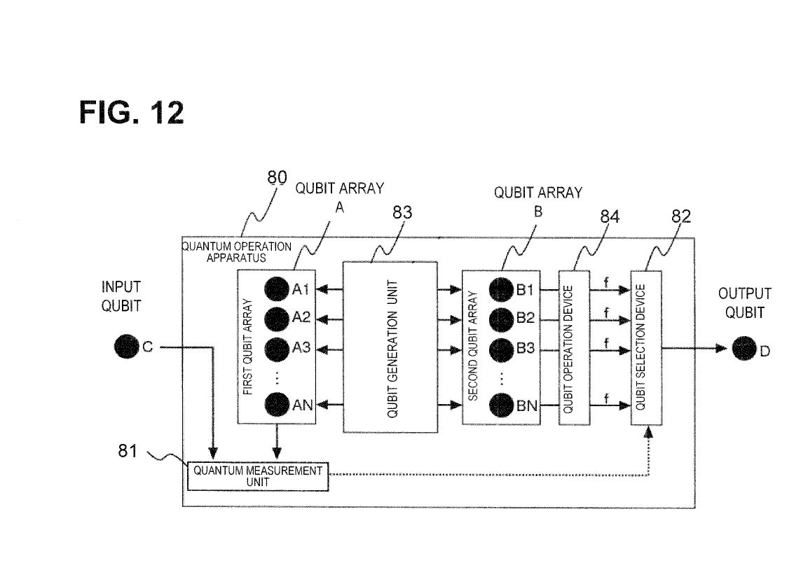

A quantum operation apparatus according to a second example is described with reference to the drawings. FIG. 12 is a block diagram illustrating a structure of a quantum operation apparatus according to the present example. With reference to FIG. 12, the quantum operation apparatus 80 receives an input qubit C and outputs an output qubits D. The quantum operation apparatus 80 comprises a quantum measurement unit 81, a qubit selection unit 82, a qubit generation unit 83, and a quantum operation unit 84.

The qubit generation unit 83 generates a first qubit array A and a second qubit array B. Qubits included in the first qubit array A are denoted by A1 to AN. Qubits included in the second qubit array B are denoted by B1 to BN. Here, N represents an integer not less than three. The qubit generation unit 83 quantum-mechanically entangles the generated first qubit array A and the generated second qubit array B.

The quantum measurement unit 81 measures an input qubit C and the first qubit array A.

The quantum operation unit 84 performs an identical quantum operation f on each of N qubits B1 to BN included in the second qubit array B.

The qubit selection unit 82 selects, in accordance with the measurement result by the quantum measurement unit 81, one qubit from the N qubits B1 to BN included in the second qubit array B, and outputs the selected qubit as the output qubit D.

The quantum operation apparatus 80, following the procedure described below, outputs the output qubit D obtained by performing a quantum operation f on the quantum state of the received input qubit C.

At first, the qubit generation unit 83 generates 2N qubits A1 to AN and B1 to BN, and generates the above quantum-mechanically entangled state |φ> from quantum states of these qubits.

The quantum operation unit 84 performs an identical quantum operation f on each of N qubits B1 to BN included in the second qubit array B.

The quantum measurement unit 81 performs a generalized measurement on the input qubit C and the first qubit array A, through which N measurement results j (j=1 to N) are obtained as POVM (Positive Operator Valued Measure) elements, each corresponds to Πⱼ hereinabove mentioned.

Finally, the qubit selection unit 82 selects a qubit Bj as the output qubit D from among the N qubits B1 to BN included in the second qubit array B.

The entangled state between the first qubit array A and the second, qubit array B in the present invention is not limited to the above |φ>. The generalized measurement in the present invention is not limited to the above POVM element Πᵢ. Although the above description is based on the examples, the present invention is not limited to the above examples.

In the framework of entire disclosure of the present invention (including the claims), and based on its basic technological concept, exemplary embodiments or examples of the present invention may be changed and/or adjusted. Also it should be noted that in the framework of the claims of the present invention, any combinations or selections of various elements disclosed herein are possible. That is, needless to say, it is understood by those skilled in the art that various changes or modifications can be made to the present invention based on the disclosure of the present invention including the claims and the technological concept of the present invention.

What is claimed is:

1. A quantum state transfer method, comprising:
measuring by a transmitting device an input qubit and a first qubit array that includes not less than three qubits; and
selecting by a receiving device in accordance with the measurement result a qubit as an output qubit from among qubits included in a second qubit array that includes not less than three qubits and is quantum-mechanically entangled with the first qubit array.

2. The quantum state transfer method according to claim 1, further comprising: generating by a qubit generation device the first and second qubit arrays.

3. The quantum state transfer method according to claim 1, further comprising quantum-mechanically entangling by the qubit generation device the first and second qubit arrays.

4. The quantum state transfer method according to claim 1, wherein the first qubit array, second qubit array, the input qubit, and the output qubit are, respectively, a composite of a plurality of qubits or a quantum system with not less than three quantum levels.

5. The quantum state transfer method according to claim 1, wherein the measurement is a POVM (Positive Operator Valued Measure) measurement.

6-9. (canceled)

10. A quantum state transfer system device, comprising:
a transmitting device that measures an input qubit and a first qubit array that includes not less than three qubits; and
a receiving device that selects in accordance with the measurement result a qubit as an output qubit from among qubits included in a second qubit array that includes not less than three qubits and is quantum-mechanically entangled with the first qubit array.

11. The quantum state transfer system device according to claim 10, further comprising: a qubit generation device that generates the first and second qubit arrays, and quantum-mechanically entangles the first and second qubit arrays.

12. The quantum state transfer system device according to claim 10, wherein the first qubit array, second qubit array, the input qubit, and the output qubit are, respectively, a composite of a plurality of qubits or a quantum system with not less than three quantum levels.

13. The quantum state transfer system device according to claim 10, wherein the measurement is a POVM (Positive Operator Valued Measure) measurement.

14-15. (canceled)

16. A quantum operation apparatus, comprising:
a quantum measurement unit that measures an input qubit and a first qubit array that includes not less than three qubits;
a quantum operation unit that performs a quantum operation on qubits included in a second qubit array that includes not less than three qubits and is quantum-mechanically entangled with the first qubit array; and
a qubit selection unit that selects in accordance with the measurement result a qubit as an output qubit from among the qubits on which the quantum operation has been performed.

17. The quantum operation apparatus according to claim 16, further comprising a qubit generation unit that generates the first and second qubit arrays, and quantum-mechanically entangles the generated first and second qubit arrays.

18. The quantum operation apparatus according to claim 16, wherein the first qubit array, second qubit array, the input qubit, and the output qubit are, respectively, a composite of a plurality of qubits or a quantum system with not less than three quantum levels.
